(19) United States
(12) Patent Application Publication
(10) Pub. No.: US 2009/0071857 A1
(43) Pub. Date: Mar. 19, 2009

(54) Content labeling of food products

(75) Inventors: James D. Astwood, Omaha, NE (US); Albert D. Bolles, Lake Forest, IL (US); Brian R. Meckna, Gretna, NE (US); Patricia T. Packard, Omaha, NE (US); Terry T. Schwartz, Omaha, NE (US); Lynda A. Deakin, Oakland, CA (US); Ian Michael Groulx, Oakland, CA (US); Byron Parr, San Francisco, CA (US); Marc H. Woollard, Oakland, CA (US)

Correspondence Address: Merchant & Gould - ConAgra, P.O. Box 2903, Minneapolis, MN, 55402, US

(73) Assignee: ConAgra Foods RDM, Inc., Omaha, NE (US)

(21) Appl. No.: 12/218,104

(22) Filed: Jul. 11, 2008

Related U.S. Application Data
(60) Provisional application No. 60/959,369, filed on Jul. 13, 2007.

(51) Int. Cl. B65D 85/00; B65C 1/02; G09F 23/00

(52) U.S. Cl. 206/459.5; 156/63; 40/637; 206/525

(57) ABSTRACT

A food label includes a food product portion providing indicia of a nutritional composition of a food product, with aspects of the indicia being coded to match aspects of a program recommendation portion of the food label.

### RELATED APPLICATIONS

This application claims the benefit of U.S. Patent Provisional Application Ser. No. 60/959,369, filed on Jul. 13, 2007 and titled “Health and wellness management program,” the entirety of which is hereby incorporated by reference.

### BACKGROUND

Proper diet is important for an individual's physical, mental, and emotional well-being. Particular food types exist that should be emphasized in the diet because they provide necessary nutrients, such as fiber, vitamins, and minerals. Other food types should be de-emphasized in the diet because they contain higher proportions of ingredients known to be detrimental to good health, such as fat, trans fat, and saturated fat.

The Department of Health and Human Services (HHS) and the Department of Agriculture (USDA) periodically publish the Dietary Guidelines for Americans (DGA). These guidelines provide advice on how dietary choices can promote health and reduce the risk for major chronic diseases. In addition, the Nutrition Facts Panel (NFP), mandated by the Federal Government under the direction of the Nutritional Labeling and Education Act of 1990 (NLEA), appears on food packages to provide consumers with analytical nutrient information about the food.

Nevertheless, achieving proper balance in an individual's diet remains challenging because the NFP only provides consumers with analytical nutrient data, such as the calories, fats, carbohydrates, protein, and vitamin or mineral content of the food. Although the NFP provides detailed nutrient information, it does not include other food-content information about the food, such as food group information. Consumers can have difficulty translating the information included in the NFP to their daily diet intake. For example, it can therefore be difficult for consumers to determine the precise quantities of food groups, such as meat and beans, grains, fruits, vegetables and dairy foods, contained within the packaged and/or prepared foods they consume. Without such information, consumers may find it difficult to achieve the fundamental DGA recommendations to eat the correct proportions from each food group.

### SUMMARY

Examples described herein relate to systems and methods for enhancing the content labeling of food products.

In one aspect, a food label includes a food product portion providing indicia of a nutritional composition of a food product, with aspects of the indicia being coded to match aspects of a program recommendation portion of the food label.

In another aspect, a package for a food product includes front and back panels defining a space therebetween sized to receive a food product, and a label on the front panel. The label includes a program recommendation portion including a food pyramid defining a plurality of wedge-shaped sections, each of the sections being color-coded to represent one food group of the food pyramid, and each of the sections being sized to be proportional to an amount of food that is recommended to be consumed for a particular food group. The label also includes a food product portion including one or more triangles, each of the triangles being color-coded to match one of the sections of the food pyramid of the program recommendation portion, and wherein each of the triangles includes text identifying one food group and a percentage identifying an amount of a daily amount satisfied by one or more servings of the food product. The program recommendation portion is positioned adjacent to the food product portion so that the food pyramid of the program recommendation portion and the triangles of the food product portion extend in a row.

In yet another aspect, a method for creating a food label for a package of a food product includes: matching composition of a food product with food groups of a food pyramid; forming one or more separate triangles for each of the food groups in the food product, the triangles each being color-coded to match one food group of the food pyramid; and placing the triangles adjacent to the food pyramid to create a food label.

The details of one or more techniques are set forth in the accompanying drawings and the description below. Other features, objects, and advantages of these techniques will be apparent from the description, drawings, and claims.

### DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is schematic view of an example food label.

FIG. 2 is a front view of an example food package.

FIG. 3 is a back view of the food package of FIG. 2.

FIG. 4 is an enlarged view of a portion of the food package of FIG. 2.

FIG. 5 is an enlarged view of a portion of the food package of FIG. 3.

FIG. 6 is an example method for creating a food label.

FIG. 7 is an example of another food label.

### DETAILED DESCRIPTION

This disclosure relates to systems and methods for enhancing the content labeling of food products. In examples described herein, nutritional labels are provided on the packaging of food products that allow consumers to readily ascertain the content of the food products.

These food labels allow consumers to more quickly and easily understand the nutritional content of the food products. In example embodiments, consumers can use this information, which can include macronutrient information (e.g., food group content), alone or in conjunction with other content information, such as the analytical nutrient information provided by the Nutrition Facts Panel (NFP), to make more informed decisions when selecting between food products for consumption.

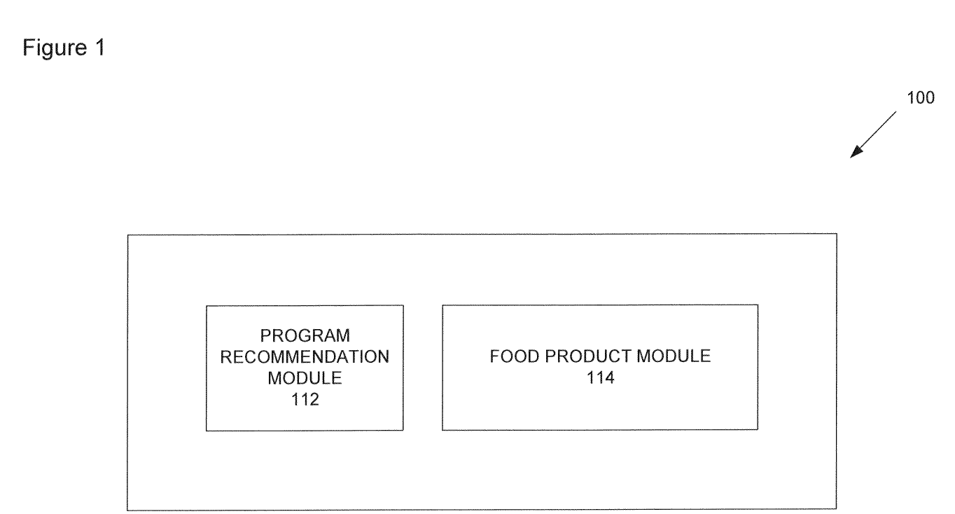

Referring now to FIG. 1, an example food label 100 is shown. In some embodiments, the food label 100 comprises printed material, stickers, indentations, watermarks, partial package inserts, leaflets, laminations, laminated leaflets, and/or over-wraps that can be affixed to or printed in conjunction with the packaging of a food product.

The food label 100 provides information related to the content of the food product, such indicia indicating the size or amount of servings (e.g., for each food group), the category of food, and/or the nutrient content (e.g., vitamins, minerals, etc.).

In some embodiments, the food label 100 is designed to be aesthetically pleasing and not visually complex. The food label 100 can be easily identified and used by a consumer to make informed food choices. The food label 100 can also allow for ready recognition of a health and/or wellness program and/or the characteristics of the food product being labeled.

For example, in some embodiments, the food label 100 can correlate the food product with goals in a health and wellness program. The overall health and wellness goals may include maintaining a healthy lifestyle or managing a chronic disease. Contributing to these goals may include choosing foods with enhanced nutritional content. For example, one such goal may be to optimize the quantities of foods having desired food group content that are consumed.

In the embodiment shown, the food label 100 includes an example program recommendation module 112 and a food product module 114. As described below, the program recommendation module 112 and the food product module 114 are configured to provide the consumer with readily discernable information about the content of the food product, including recommendations related to a specific food program.

The program recommendation module 112 of the food label 110 provides information about the recommendations related to the particular food program illustrated by the food label 110. For example, as described herein, the program recommendation module 112 can provide food group information related to the food pyramid. However, in other embodiments, the program recommendation module 112 can provide information related to other recommendation programs as well. For example, in another alternative, the program recommendation module 112 can provide information related to a particular diet program, such as a diet program that emphasizes consumption of certain types of foods over others. In other examples, the program recommendation module 112 can relate to other types of recommendation programs, such as exercise or training programs that correlate food intake to particular training goals. Other configurations are possible.

In the examples described herein, the program recommendation module 112 provides indicia related to the different food groups and oils. This indicia can include text, graphics, icons, and/or colors that represent the food pyramid. As described further below, in some embodiments, the program recommendation module 112 includes a graphical representation of the various foods making up the food pyramid. In one example, the program recommendation module 112 includes the MyPyramid logo utilized by the U.S. Department of Agriculture (USDA) to indicate the different recommended food groups. Other configurations are possible.

In example embodiments, the food product module 114 of the food label 100 is positioned adjacent to the program recommendation module 112. The food product module 114 includes indicia of the content of the food product contained in the packaging to which the food label 100 is affixed. In example embodiments, the food product module 114 includes a graphical representation of food content information, and the information provided by the food product module 114 is correlated with the information provided in the program recommendation module 112.

In the example shown, the food product module 114 includes information relating to one or more of the food groups and the percentage of the recommended daily amount for each food group. In alternative embodiments, the food product module 114 can represent the content of the food product in other manners. For example, the food product module 114 can instead include the number of servings for each food group, or the amount of cups, ounces, or other household measures for each food group. In other examples, a sliding scale can be used so that the percentage daily amount of each food group is adjusted based on a specific diet, such as a typical 2000 calorie diet, a 1500 calorie diet, or a 2500 calorie diet. The food product module 114 is configured to be flexible so that the food product module 114 can be adjusted as needed. For example, if a change is made in the recommended amount of one or more food groups (e.g., the recommended amount from the Dietary Guidelines for Americans (DGA)), the food product module 114 can be adjusted to reflect the change.

In example embodiments, the food product module 114 includes text or icons that represent the content of the food product. For example, as described further below, the food product module 114 can include graphical representations, such as icons, with numbers representing the amount of servings of a particular component of the food product, along with text specifying the particular component, such as the food group. The icons can be formed of different shapes or designs, such as triangles, pyramids, circles, squares, rectangles, ovals, and other shapes as desired. In other examples, other types of representations can be used, such as charts (e.g., bar or pie charts).

The particular components of the food product shown in the food product module 114 are correlated (e.g., using colors, shapes, text, etc.) with the food pyramid shown in the program recommendation module 112. For example, the represented food components can relate to the USDA food pyramid program and/or other program recommendations made by governmental organizations or other entities. Particular components of food may include vegetables, fruit, meat and beans (protein), grains, fats, dairy products, fats and oils. In alternative embodiments, not all of the food groups need to be represented.

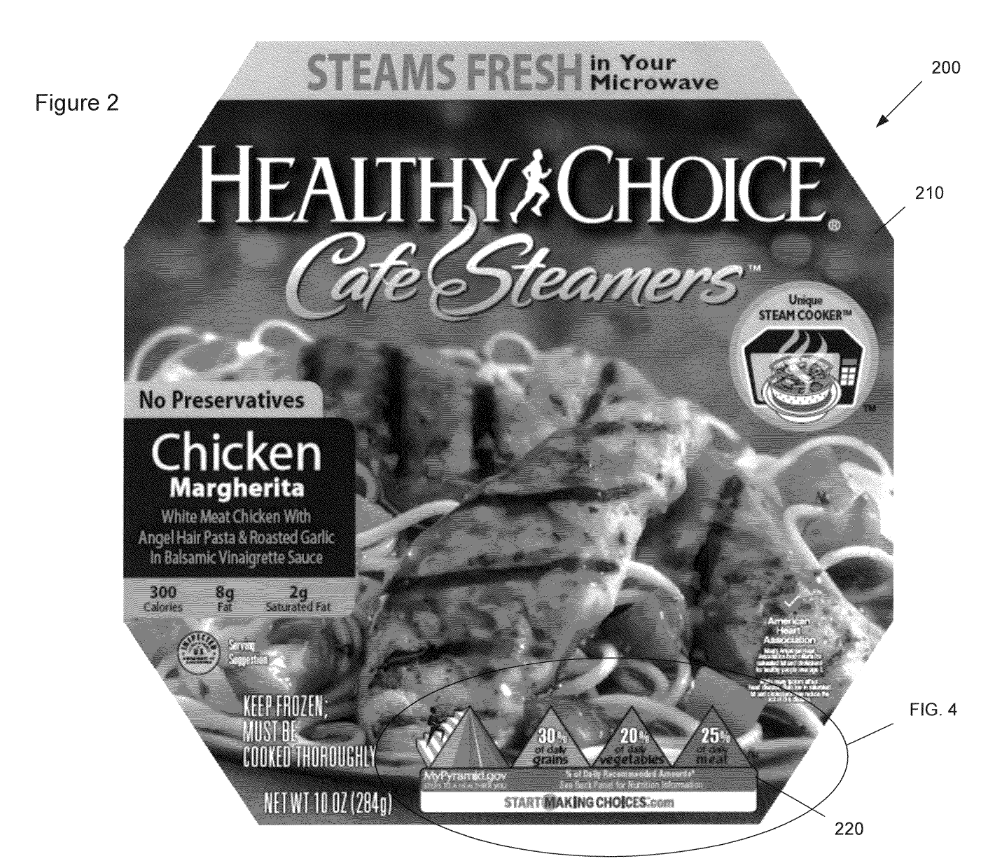

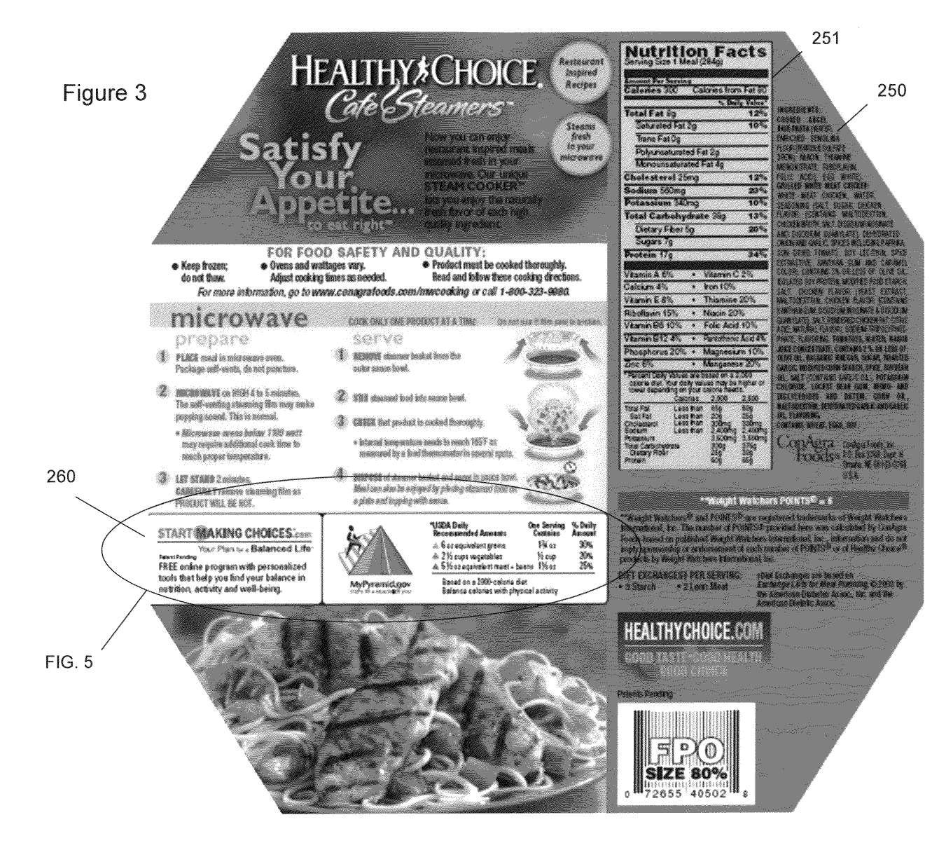

Referring now to FIGS. 2-5, an example food package 200 is shown. The food package 200 contains one or more food products, such as a prepared and/or packaged food.

The food package 200 includes front and back panels or sides 210, 250. The front and back sides 210, 250 include food product information, such as a product name, product pictures, preparation instructions, and product content information. The content information includes a food label 220 located on the front side 210 and a food label 260 located on the back side 250. An NFP 251 is also shown that provides analytical nutrient information related to the food product.

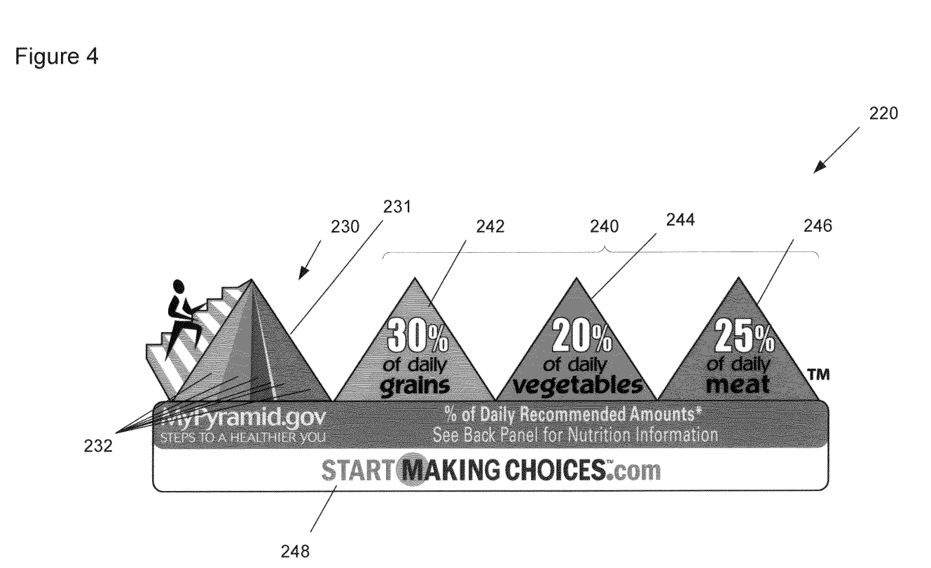

Referring to FIG. 4, the food label 220 includes an example food group module 230, food product module 240, and information module 248.

In the embodiment shown, the food group module 230 includes indicia of the different food groups. In this example, the food group module 230 includes an icon or symbol 231 formed as the USDA MyPyramid symbol that is used to provide a simplified visual representation of the food pyramid. The symbol 231 is formed as a pyramid that is divided into six triangular or wedge-shaped sections 232. The sections 232 represent the five food groups of the food pyramid, as well as oils. Each of the sections 232 is coded by color to represent a specific one of the food groups, such as:
grains—orange;
vegetables—green;
fruits—red;
milk—blue;
meats and beans—purple; and
oils—yellow.
   Other coding schemes, such as alternative colors or shading, icons, text, etc., can also be used.

In this embodiment, the width of each of the sections 232 is proportionally sized to suggest how much food should be chosen from each of the food groups. For example, the width of the grains section 232 is larger than the oils section 232 because a larger portion of a person's diet should include grains. Other configurations are possible.

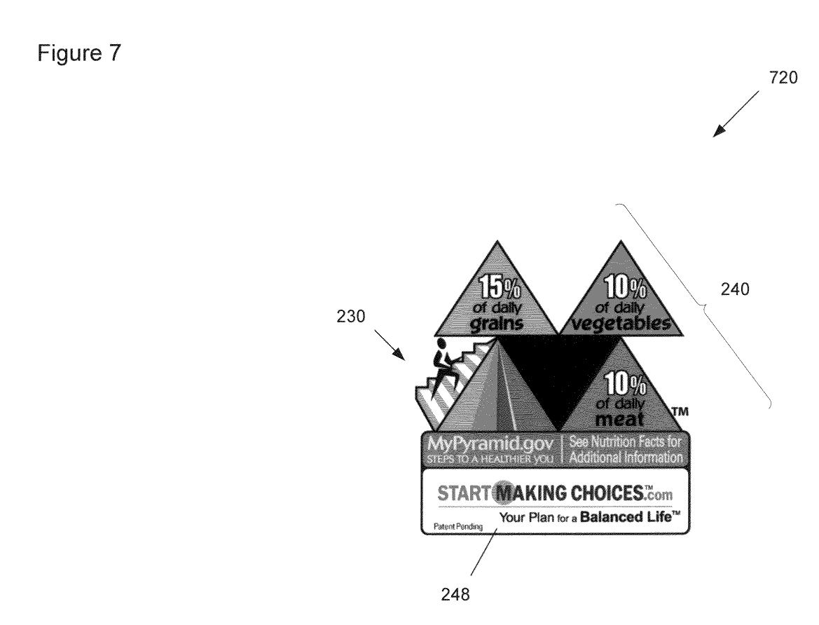

The food product module 240 of the food label 220 includes triangles 242, 244, 246. In the example shown, the triangles 242, 244, 246 extend longitudinally in a row positioned adjacent to the food group module 230. Other configurations, such as extending the triangles vertically or in a staggered pattern depending on the size and/or configuration of the food product packaging, can also be used. For example, in another food label 720 shown in FIG. 7, the triangles in the food product module 240 are arranged in a stacked configuration.

Referring again to FIG. 4, each of the triangles 242, 244, 246 represents aspects of the food group content of the food product that is contained in the food package 200. For example, the triangle 242 indicates textually that the food product includes “30% of daily grains.” Also, the triangle 242 is coded with the same color (e.g., orange) as that of the grain section 232 of the symbol 231 of the food group module 230. The triangles 244, 246 similarly include food group content information and are color-coded (e.g., triangle 244 is green for vegetables, and triangle 246 is purple for meats).

In the example shown, the triangles 242, 244, 246 are listed in the same order as that of the sections 232 of the symbol 231. In other examples, the triangles can be listed in ascending or descending order based on the amount of each food group (gross or percentage), or can be ordered based on importance of the food group (e.g., grains listed before oils). Other configurations are possible.

Although three triangles are provided in the example food product module 240, more or fewer triangles can be provided depending on the number of food groups contained within the food product. For example, if items from four food groups are included in a food product, four triangles can be provided to represent the different food groups. Also, in alternative embodiments, the triangles can be coded in other manners as well, such as by increasing or decreasing the size (e.g., height, width, and/or volume) of each triangle depending on how much of the recommended daily allowance is satisfied. Other configurations are possible.

The use of the color-coded triangles that correlate to aspects of the food pyramid allows the consumer to readily determine the food-group content of the food product. Placement of the food label can allow the consumer to quickly and easily estimate the dietary contribution of the food product. The consumer can use this information to make more informed decisions when selecting between food products for consumption.

The information module 248 of the food label 220 includes references to additional resources related to the program recommendations and/or content provided by the food label. For example, the information module 248 includes a reference to the USDA web site (mypyramid.gov) that provides information on the MyPyramid program. The information module 248 also provides a reference to the back side 250 of the food package 250 for additional content information, such as nutrient information. The information module 248 also includes a reference to a web site (startmakingchoices.com) associated with the food product manufacturer that helps consumers make healthy eating and lifestyle decisions. Other information can also be provided.

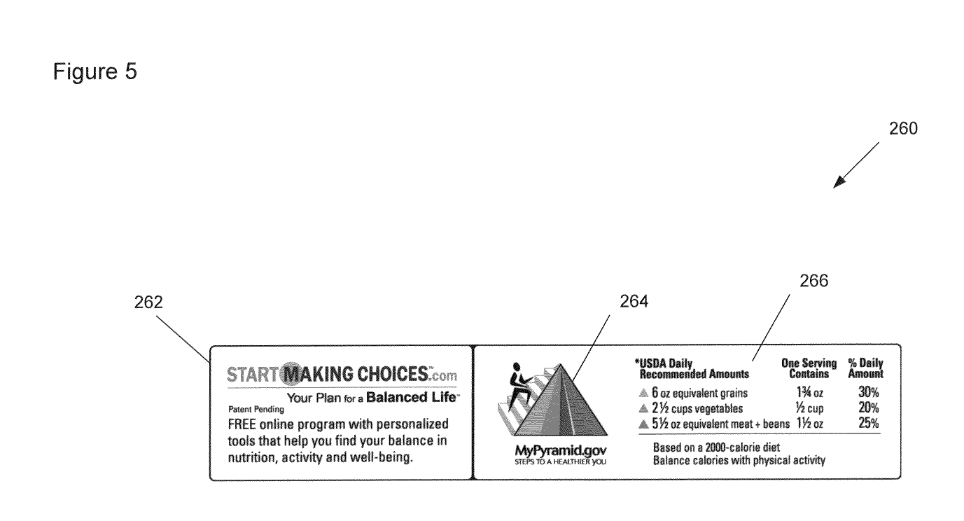

Referring to FIG. 5, the food label 260 on the back side 250 of the food package 200 includes an information module 262, a food group module 264, and a food product module 266.

The information module 262 includes additional details about other resources for information, such as online resources. The food group module 264 includes the USDA MyPyramid symbol.

The food product module 266 again provides details on the food group content of the food product that is in the food package 200. These details include the DGA recommendations, which include color-coded mini-triangles next to each daily amount value. The colors of the mini-triangles match the colors of the sections of the MyPyramid symbol. Also, the food product module 266 includes the amount contained in each serving of the food product and the percentage of recommended daily amount.

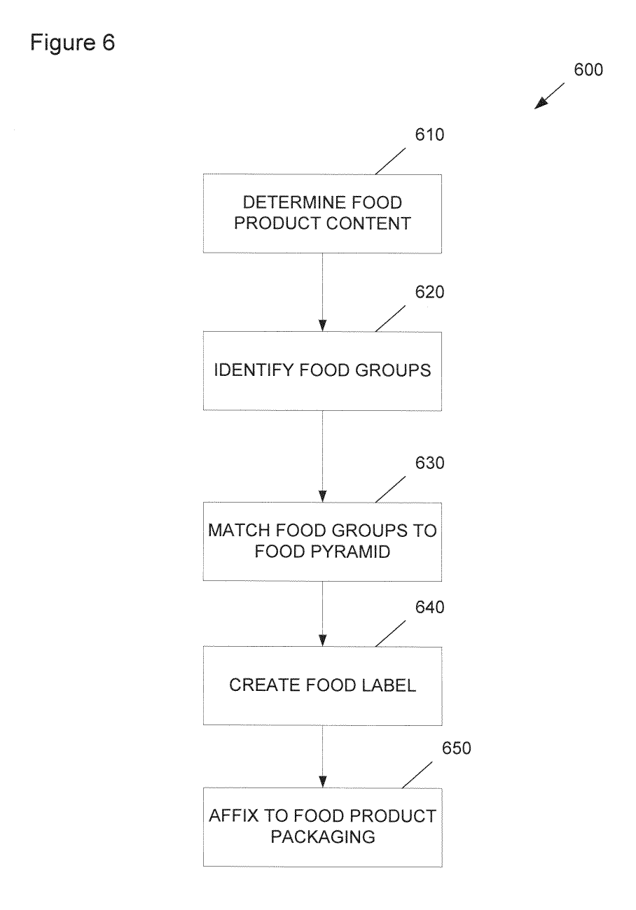

Referring now to FIG. 6, an example method 600 for creating a food label for packaging of a food product is shown.

Initially, at operation 610, the food product formula is reviewed to determine its composition. In some examples, operation 610 is not necessary if the composition of the food product has already been determined.

Next, at operation 620, the relevant food groups are identified based on the composition of the food product. For example, if the food product includes grains and vegetables, the grain and vegetable food groups are identified and quantities determined.

Various methods can be used to determine the food group content of the food product. In one example, the composition of the food product, such as the list of ingredients, is examined and “batched” into the various food groups. Adjustments are then made based on the type of ingredient. For example, if the ingredient is a meat, an adjustment may need to be made depending on the fat content of the meat. In another example, if the ingredient is a vegetable, an adjustment may need to be made depending on how the vegetable is consumed. If the vegetable is a frozen ingredient in the food package, an adjustment may need to be made if the ingredient is modified (e.g., water content added) prior to consumption by the consumer.

Once necessary modifications are made, the amount of each food group is estimated based on the batches. For example, in one embodiment, each ingredient is expressed as a percentage of the total food product. Each batch representing a food group is therefore calculated as a percentage of the entire food product. Once the total percentage is known, the percentage is used along with the net weight of the food product to calculate the total amount of each food group. In one example, the meats and grains food group contents are expressed in ounces, and the vegetables, fruits, and milk food group contents are expressed in cups, although other configurations are possible.

Next, control is passed to operation 630, at which the food groups are matched to the food pyramid. For example, if the grain and vegetable foods groups are present in the food product, triangles that are coded for these food groups are selected.

Next, at operation 640, the food label is created. The food label includes both the program recommendation information (e.g., the food pyramid) and the food product information (e.g., triangles representing the food groups that are included in the food product).

Finally, at operation 650, the food label is applied to the food product packaging. This can involve incorporating the food label into the overall printing of the food package or applying the food label to existing food packaging by, for example, printing the food label thereon or applying as a sticker. In example embodiments, the food label can be shown in multiple places (e.g., front, back, and/or side) of the packaging.

Alternative configurations are possible. For example, in other embodiments, text can be used in addition to or in place of color coding to identify each of the food groups in the program recommendation and food product modules of the food label. In other examples, icons (e.g., a loaf of bread for the grain food group and a carrot for the vegetable food group) can be used to represent the different food groups.

In another embodiment, the food label can be positioned on places other than the food package. For example, the food label can be placed on a shelf, a SKU, or a banner associated with the food product in a store, can be placed on a menu in a restaurant, and/or can be placed in an advertisement for the food product. Other configurations are possible.

The various embodiments described above are provided by way of illustration only and should not be construed as limiting. Various modifications and changes that may be made to the embodiments described above without departing from the true spirit and scope of the disclosure.

What is claimed is:

1. A food label comprising a food product portion providing indicia of a nutritional composition of a food product, with aspects of the indicia being coded to match aspects of a program recommendation portion of the food label.

2. The label of claim 1, wherein the nutritional composition is a food group composition of the food product.

3. The label of claim 2, wherein the program recommendation portion includes a graphical representation of a food pyramid.

4. The label of claim 3, wherein the food pyramid includes a plurality of sections, with each of the sections representing one food group.

5. The label of claim 4, wherein each of the sections of the food pyramid is color-coded.

6. The label of claim 5, wherein the indicia of the food product portion includes at least one triangle including color-coding to match one of the sections of the food pyramid of the program recommendation portion.

7. The label of claim 6, wherein the graphical representation of the food product portion includes a plurality of triangles, each including color-coding to match one of the sections of the food pyramid of the program recommendation portion.

8. The label of claim 6, wherein the triangle also includes text identifying one food group and a percentage identifying an amount of a daily allowance satisfied by a serving of the food product.

9. The label of claim 6, wherein the food pyramid of the program recommendation portion is positioned adjacent to the triangle of the food product portion.

10. The label of claim 6, wherein the graphical representation of the food product portion includes a plurality of triangles, each including color-coding to match one of the sections of the food pyramid of the program recommendation portion, and wherein the food pyramid of the program recommendation portion is positioned adjacent to the plurality of triangles.

11. A package for a food product, the package comprising:
front and back panels defining a space therebetween sized to receive a food product; and
a label on the front panel, the label including:
a program recommendation portion including a food pyramid defining a plurality of wedge-shaped sections, each of the sections being color-coded to represent one food group of the food pyramid, and each of the sections being sized to be proportional to an amount of food that is recommended to be consumed for a particular food group; and
a food product portion including one or more triangles, each of the triangles being color-coded to match one of the sections of the food pyramid of the program recommendation portion, and wherein each of the triangles includes text identifying one food group and a percentage identifying an amount of a daily amount satisfied by one or more servings of the food product;
wherein the program recommendation portion is positioned adjacent to the food product portion so that the food pyramid of the program recommendation portion and the triangles of the food product portion extend in a row.

12. The package of claim 11, wherein the label further includes an information portion including references to one or more resources having additional program recommendation information or food product content information.

13. The package of claim 12, wherein the information portion is located below the program recommendation portion and the food product portion.

14. A method for creating a food label for a package of a food product, the method comprising:
matching composition of a food product with food groups of a food pyramid;
forming one or more separate triangles for each of the food groups in the food product, the triangles each being color-coded to match one food group of the food pyramid; and
placing the triangles adjacent to the food pyramid to create a food label.

15. The method of claim 14, further comprising adding text to each of the triangles to identify one of the food groups and a percentage identifying an amount of a daily amount satisfied by a serving of the food product.

16. The method of claim 14, further comprising positioning the triangles to extend in a row adjacent to the food pyramid.

17. The method of claim 16, further comprising ordering the triangles to match an order of the food groups in the food pyramid.

18. The method of claim 14, further comprising positioning information related to additional program recommendation resources adjacent to the triangles.

19. The method of claim 18, further comprising positioning the information below the triangles.

20. The method of claim 14, further comprising determining the food groups included in the food product.
